(19) United States
(12) Patent Application Publication
(10) Pub. No.: US 2006/0010623 A1
(43) Pub. Date: Jan. 19, 2006

(54) Electric toothbrush with three dimensional motion

(76) Inventors: Scott Philip Crossman, Rockford, MI (US); Christopher D. Bryan, Grand Rapids, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/891,378

(22) Filed: Jul. 14, 2004

(51) Int. Cl. A61C 17/22

(52) U.S. Cl. 15/22.1; 15/22.2; 15/28

(57) ABSTRACT

An electric toothbrush including a handle, a battery and a motor in the handle, a head, and a tuft carrier movably mounted on the head for oscillation about an axis. The tuft carrier also moves axially as the carrier oscillates. This three-dimensional motion is provided by a plurality of cams and a plurality of cam followers on the head and the tuft carrier. The cam followers engage the cams such that as the tuft carrier oscillates back-and-forth, the cam followers ride up and down over the cams consequently raising and lowering the tuft carrier with respect to the toothbrush head.

### BACKGROUND OF THE INVENTION

The present invention relates to electric toothbrushes, and more particularly to an electric toothbrush with three-dimensional motion.

Electric toothbrushes are well known and believed to increase plaque removal and prevent gum recession. Conventional electric toothbrushes include an elongated body with a handle at one end and a head at the other end. The head end supports a cylindrical tuft carrier containing a number of tufts of bristles. The tuft carrier is provided with a back-and-forth reciprocating and oscillating motion a by drive shaft and motor located within the body of the toothbrush. The drive shaft rotates about a longitudinal axis and includes an eccentric tip that engages a slot in the side wall of the tuft carrier so that the tuft carrier oscillates as the tip rotates.

In an effort to improve the cleaning effect of electric toothbrushes, manufacturers are now attempting to develop tuft carriers with three-dimensional motion, the third dimension being generally perpendicular to the oscillating dimensions. For example, U.S. Pat. No. 5,974,613 issued Feb. 19, 2002 to Fattori discloses a tuft carrier that is pivotally mounted on an angled drive shaft. The drive shaft extends through a lower portion of the tuft carrier, so that tuft carrier pivots back and forth as the drive shaft rotates. U.S. Pat. No. 6,347,425 issued Nov. 2, 1999 to Herzog discloses a drive shaft with an eccentric tip that engages a hole in the side wall of the tuft carrier. The tuft carrier pivots back and forth within a socket as the shaft rotates. While these and other designs provide their respective electric toothbrushes with some degree of three-dimensional motion, a significant amount of additional manufacturing time and labor is required to produce these specially made drive shafts and tuft carriers.

Accordingly, manufacturers in this competitive market are continually searching for simpler and more cost-effective ways to provide electric toothbrushes with three-dimensional motion.

### SUMMARY OF THE INVENTION

The aforementioned problems are overcome by the present invention wherein three-dimensional motion is produced by simply molding cooperating features into the head and tuft carrier of a electric toothbrush to provide movement in the axial direction as the tuft carrier oscillates. In the disclosed embodiment, the cooperating features are cams and cam followers. The cam engages the cam follower such that as the tuft carrier reciprocates back-and-forth the cam rides up and down over the cam follower, consequently raising and lowering the tuft carrier with respect to the toothbrush head.

The present invention provides an efficient and cost effective means for providing an electric toothbrush with three-dimensional motion. The cams and cam followers that provide up-and-down motion can be molded integrally into the body and the tuft carrier of a conventional electric toothbrush.

These and other objects, advantages, and features of the invention will be more fully understood and appreciated by reference to the detailed description of the current embodiments and the drawings.

### BRIEF DESCRIPTION OF THE DRAWINGS

FIG. 1 is a perspective view of an electric toothbrush in accordance with the present invention.

FIG. 2 is an exploded view of the electric toothbrush.

FIG. 3A is a cross-sectional view of the tuft carrier in a first position.

FIG. 3B is a cross-sectional view of the tuft carrier in a second position.

FIG. 4 is a perspective view of the bottom and side wall tuft carrier.

FIG. 5 is an exploded view of an electric toothbrush according to a first alternative embodiment.

FIG. 6 is a cross-sectional view of the first alternative embodiment.

FIG. 7 is a bottom view of the tuft carrier according to the first alternative embodiment.

### DETAILED DESCRIPTION OF THE PREFERRED EMBODIMENT

### I. First Embodiment

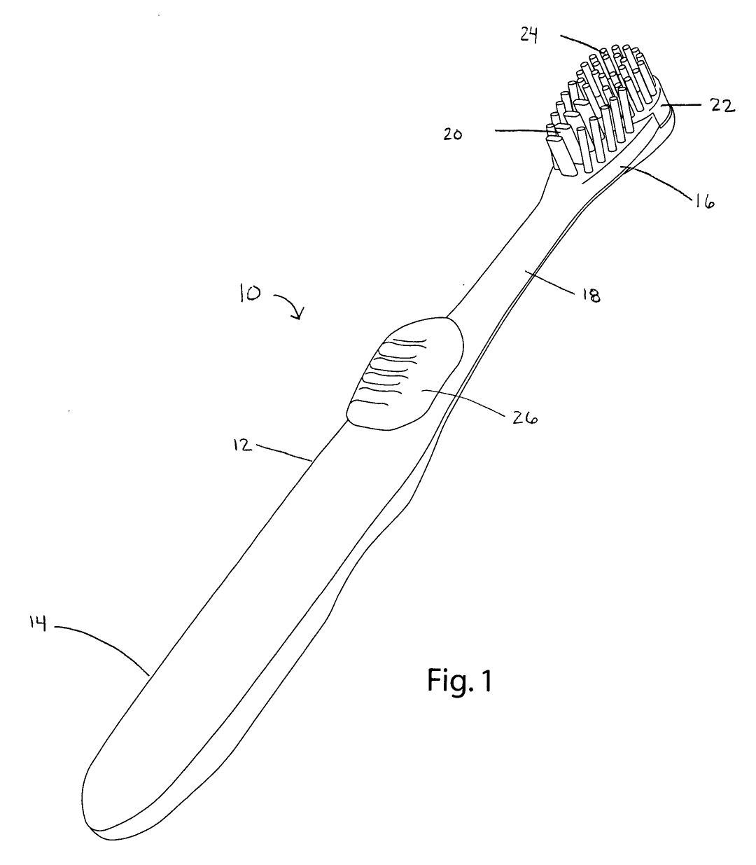

As shown in FIG. 1, the present invention is directed to an electric toothbrush that is generally designated 10. The toothbrush includes an elongated body 12 having a handle 14 at one end, a head 16 at the other end, and a neck 18. The head 16 includes a plurality of stationary bristles 20, and supports a tuft carrier 22, also having a plurality of bristles 24. In operation, a switch 26 is activated by a user and an electric motor inside the body 12 provides motion to the tuft carrier 22.

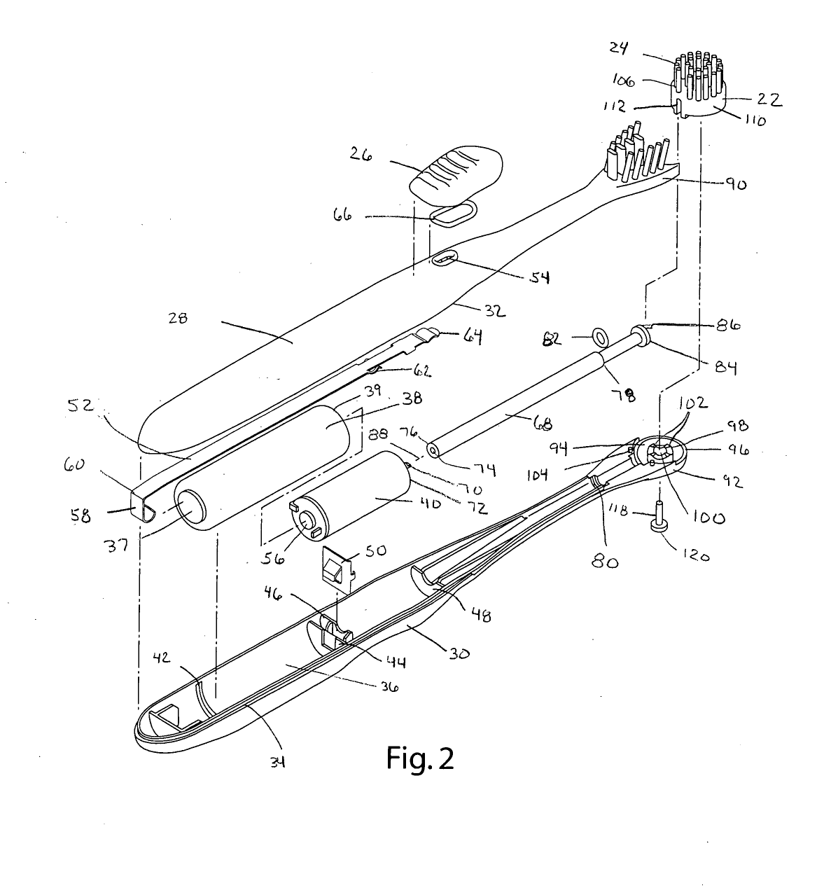

Referring now to FIG. 2, the body 12 includes an upper body 28 and a lower body 30. The upper body 28 and lower body 30 are preferably molded plastic, and are conventionally attached around a peripheral edge 32 of the upper body 28 and a corresponding edge 34 of the lower body 30 to create a hollow inner chamber 36.

The inner chamber 36 generally includes a battery 38 or multiple batteries, such as a AA form battery, and a cylindrical direct current motor 40 positioned within the handle 14. The battery 38 is held in place by ribs 42 and 44, and the motor 40 is held in place by ribs 46 and 48. The ribs 42, 44, 46, and 48 extend around the wall of the chamber 36 on both the upper body 28 and the lower body 30. Ribs 44 and 46 are positioned in between the motor 40 and the battery 38. A positive metal stamping 50 is disposed between the ribs 44 and 46 to connect one terminal 37 of the battery 38 to a first end 56 of the motor 40. A negative metal stamping 52 is attached to the switch 26 through an elongated slot 54 in the upper body, such that when the switch 26 is moved along the slot 54, the stamping 52 slides along the upper surface of the upper body 28 within the chamber 36. The negative stamping 52 includes a flange 58 extending downwardly from a first end 60, and a pair of fingers 62 extending downwardly from a point near the second end 64. A sealing O-ring 66 is disposed between the switch 26 and the upper body 28.

A drive shaft 68 is attached to drive pin 70 extending from a second end 72 of the motor 40. The drive shaft 68 is preferably a plastic rod, but may be made from a variety of materials. The pin 70 interfits with a hole 74 on a first end 76 of the drive shaft 68 and provides rotational motion to the drive shaft 68 when the motor 40 is activated. The drive shaft 68 is generally an elongated cylinder that extends through the inner chamber 36 from the neck 18 to the head 16 to define a longitudinal axis 88. A central portion 78 of the shaft 68 is supported by a rib 80 within the neck 18. A second sealing O-ring 82 is disposed about the central portion 78 within the rib 80. A second end 84 of the drive shaft 68 includes an eccentric finger 86 that extends from the drive shaft at a slight angle with the axis 88 and engages a slot 112 in the tuft carrier 22 (described below in detail).

The toothbrush head 16 includes a portion 90 of the upper body 28, a portion 92 of the lower body 30, and the tuft carrier 22. The upper body portion 90 includes a plurality of stationary bristles 20. The bristles 20 are generally conventional, and may be of various sizes, cross-sections and strengths and may extend from the upper portion 90 at various angles. Alternatively, or additionally, the toothbrush may include an elastomer extending from upper portion 90. The lower body portion 92 extends past the upper portion 90 and includes an mounting surface 94. The mounting surface 94 includes a generally circular wall 96 extending upwardly at the periphery of the surface 94, a pair of stop pins 104, and a receptacle 98 defining a hole 100 in the surface 94 and a wall extending upwardly from the center of the surface 94. The receptacle 98 further includes a plurality of evenly spaced cams 102 extending around its upper surface. As illustrated, the present invention includes four cams, however, any desired number of cams 102 may be used.

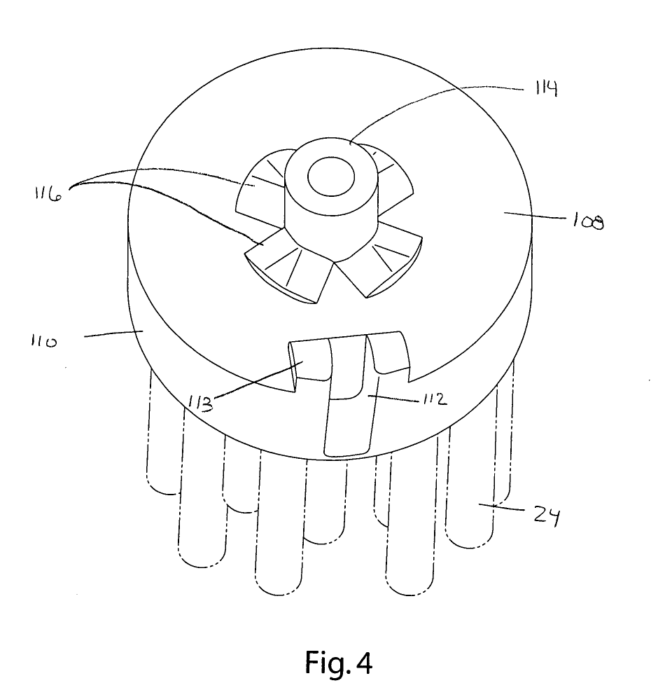

The tuft carrier 22 is generally circular to correspond to the shape of the peripheral wall 96 of the mounting surface 94, and includes an upper surface 106, a lower surface 108, and a side wall 110. The upper surface 106 includes a plurality of conventional bristles 24. The side wall 110 includes a slot 112 that extends up a substantial portion of the side wall 110 from the lower surface 108. The lower surface 108 is generally flat, but as shown in FIG. 4 it includes a pair of stop fingers 113 extending down from either side of the slot 112, a boss 114 extending from the center of the surface 108, and a plurality of cam followers 116 evenly spaced about the boss 114. The number of cam followers 116 generally correspond to the number of cams 102, however, this is not necessary. The boss 114 is sized so that is can fit within the receptacle 98. The cam followers 116 are sized to engage the cams 102 when the boss 114 is fitted within the receptacle 98. A pin 118 with a head 120 extends through the receptacle 98 and the boss 114 to attach the tuft carrier 22 to the mounting surface 94. The length of the pin 118 allows the tuft carrier to move a small distance up and down with respect to the mounting surface 94. The pin 118 may be press fit into the boss 114, or may be conventionally attached for example by a sonic weld. A spring (not shown) may be placed between the pin 118 and the lower body 92 of the head to keep the cams 102 and cam followers 116 in constant contact.

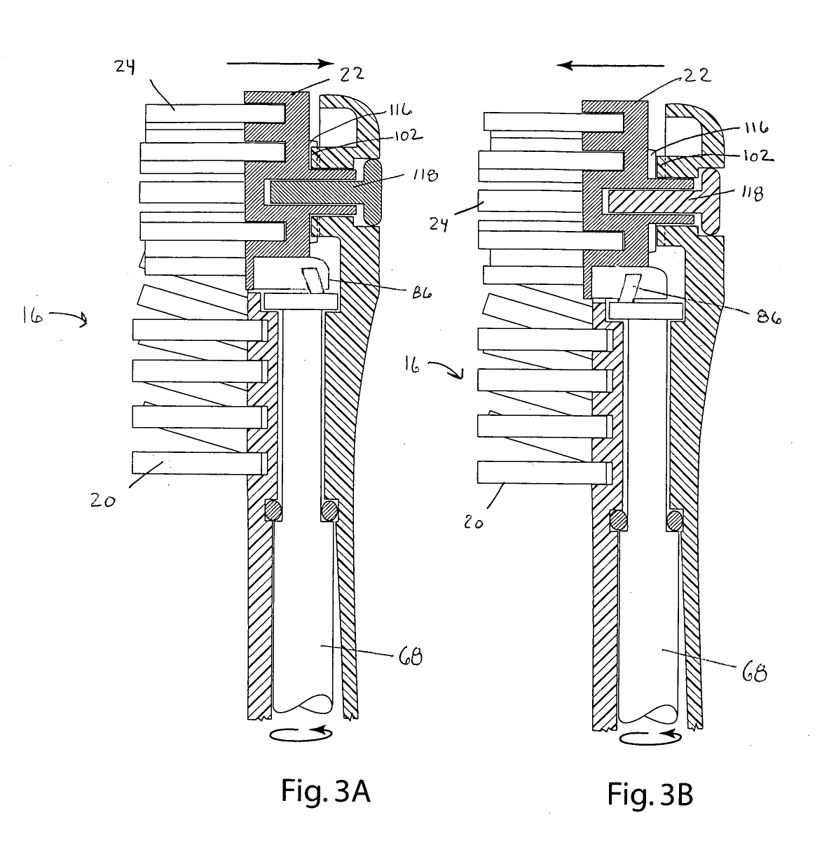

In operation, the switch 26 is actuated within the slot 54 so that the flange 58 and the fingers 62 on the negative stamping 52 contact the second terminal 37 of battery 38 and the motor 40 to complete a circuit. The motor 40 then rotates the drive pin 70 and in turn the drive shaft 68 and the finger 86. The finger 86 engages the slot 112 of the tuft carrier 22, and moves up and down within the slot 112. In turn, the tuft carrier 22 reciprocates back and forth along an arcuate path, while the cam followers 116 run up and down over the cams 102. The tuft carrier 22 thereby raises and lowers as it reciprocates. FIG. 3A shows the actuation of the drive shaft 68 with the tuft carrier 22 in a first, lower position. FIG. 3B shows the actuation of the drive shaft 68 with the tuft carrier 22 in a second, raised position.

### II. Second Embodiment

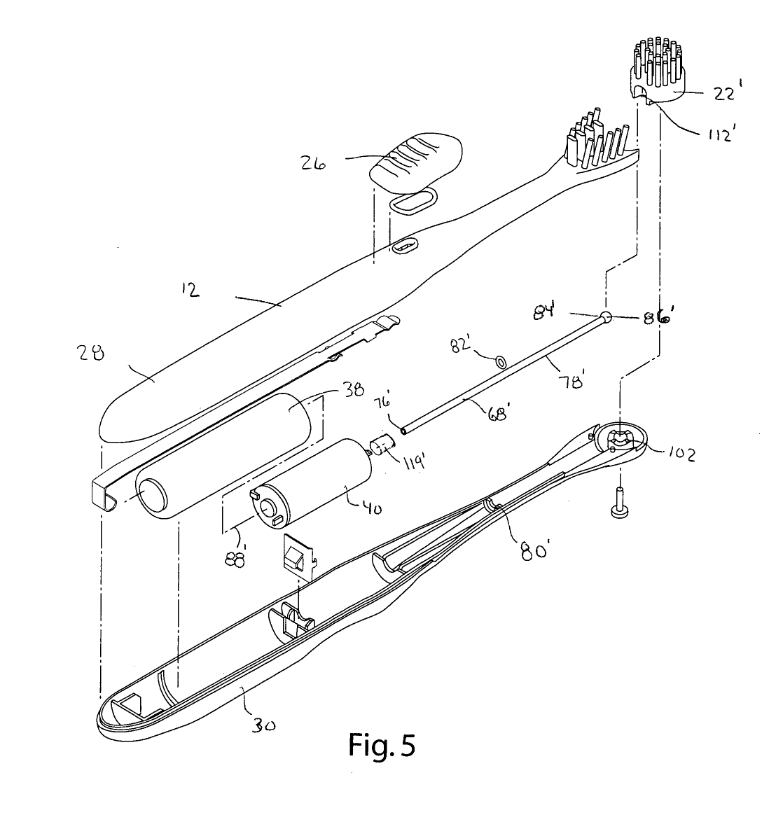

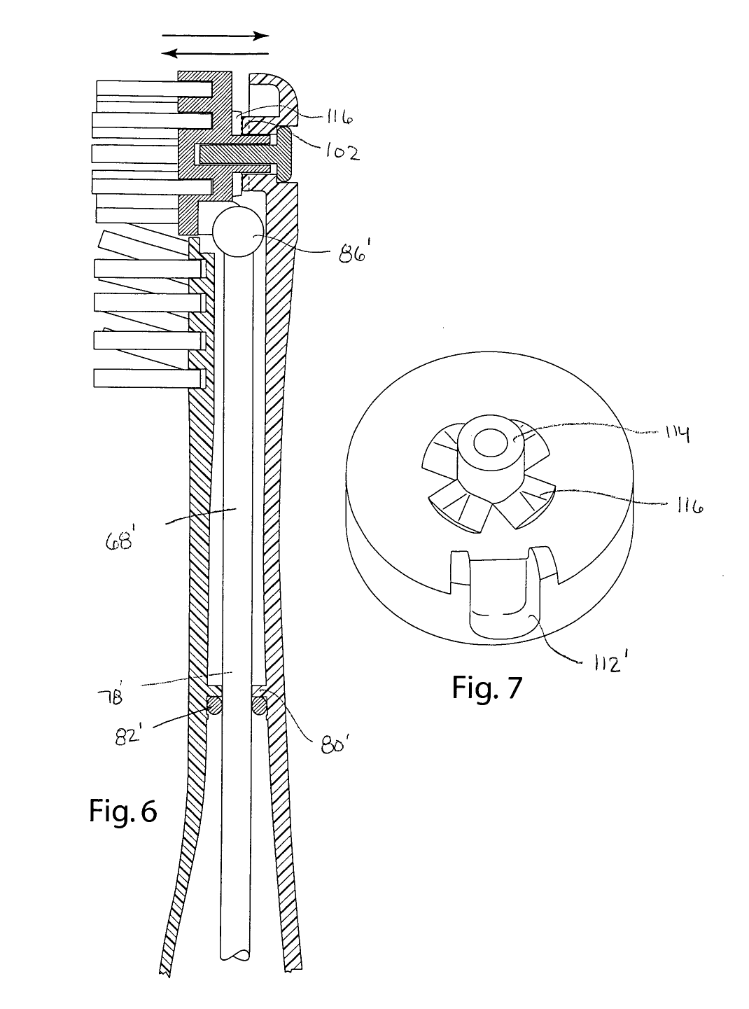

FIGS. 5-7 show an alternative configuration of the drive shaft 68′ and tuft carrier 22′. In this configuration, the end 84′ of the drive shaft 68′ does not require the eccentric finger 86 of the previously disclosed embodiment. The drive shaft 68′ may terminate in a variety of shapes. As shown, the drive shaft 68′ terminates in a ball 86′. The drive shaft 68′ includes a central portion 78′ supported by a rib 80′ and a sealing O-ring 82′ as in the previously disclosed embodiment, but in this embodiment the rib 80′ is positioned substantially farther from the end 84′. The first end 76′ of the drive shaft 68′ engages with a drive cam 119′ attached to the motor 40′ so that the end 76′ of the drive shaft is eccentric with the axis 88′. The drive shaft 68′ is preferably steel, but may also be plastic or another suitable material. The tuft carrier 22′ includes a socket 112′ to accommodate the ball 86′. The remaining parts of the toothbrush are generally the same.

In operation, when the switch 26 is actuated the cam shaft 119′ rotates and the first end 76′ of the drive shaft 68′ travels in a circular path about the axis 88′, causing the central portion 78′ of the shaft 68′ to pivot about a fulcrum created by the rib 80′. This causes the ball 86′ to travel eccentric to the longitudinal axis 88′ and reciprocates the tuft carrier 22′. The cams 102 and cam followers 116 operate in the same manner as the previously disclosed embodiment to provide the tuft carrier 22′ with a three-dimensional motion.

The above descriptions are those of current embodiments of the invention. Various alterations and changes can be made without departing from the spirit and broader aspects of the invention, which are to be interpreted in accordance with the principles of patent law including the Doctrine of Equivalents.

The embodiments of the invention in which an exclusive property or privilege is claimed are defined as follows:

1. A power actuated toothbrush comprising:
a body having a handle portion and a head portion including a mounting portion;
a tuft carrier having an upper portion supporting a plurality of bristles and a lower portion engaging said mounting portion, said tuft carrier supported for movement along a line or in a plane;
drive means for reciprocating said tuft carrier along the line or in the plane; and
said mounting portion and said lower portion cooperating to move said tuft carrier in a direction transverse to the line or plane as said tuft carrier moves along the line or in the plane.

2. The power actuated toothbrush of claim 1 wherein said mounting portion includes a cam and said lower portion includes a cam follower engaging said cam.

3. The power actuated toothbrush of claim 1 wherein:
said tuft carrier defines an axial slot; and
said drive means includes a drive shaft including a tip riding within said slot.

4. The power actuated toothbrush of claim 3 wherein the second direction is transverse to said drive shaft.

5. The power actuated toothbrush of claim 1 wherein the movement in a plane is an arcuate reciprocating motion.

6. The power actuated toothbrush of claim 2 including a plurality of said cams and a plurality of said cam followers.

7. The power actuated toothbrush of claim 3 wherein said tip travels eccentric with respect to said drive shaft.

8. A power actuated toothbrush comprising:
an elongated body containing a handle at one end and a head at the other end, said head including a mounting surface;
a tuft carrier mounted on said head, said tuft carrier including an upper surface and a lower surface, said upper surface containing a plurality of bristles, said lower surface engaging said mounting surface, one of said tuft carrier surface and said mounting surface including a cam, and the other including a cam follower; and
drive means for providing reciprocating motion of said tuft carrier relative to said head such that said cam rides up and down on said cam follower as said tuft carrier reciprocates.

9. The power actuated toothbrush of claim 8 wherein said tuft carrier includes a side wall defining a slot.

10. The power actuated toothbrush of claim 9 wherein said drive means includes a power actuated drive shaft that rotates about a longitudinal axis, said drive shaft including a tip that travels eccentric with said longitudinal axis, said tip engaging said slot in said tuft carrier.

11. The power actuated toothbrush of claim 10 wherein said reciprocating motion of said tuft carrier is transverse to said longitudinal axis.

12. The power actuated toothbrush of claim 11 wherein said reciprocating motion of said tuft carrier is an arcuate reciprocating motion.

13. The power actuated toothbrush of claim 8 including a plurality of cams circumferentially spaced about said boss or said receptacle, and a plurality of cam followers circumferentially spaced about said boss or said receptacle.

14. The power actuated toothbrush of claim 13 wherein said tip includes a finger eccentric with said longitudinal axis, said finger engaging said slot on said tuft carrier.

15. A head for a power actuated toothbrush comprising:
a tuft carrier having an upper surface, a lower surface, and a peripheral edge, said upper surface containing a plurality of bristles;
a mounting surface attached to the body of a power actuated toothbrush, said mounting surface mounted to said tuft carrier and interfit with said lower surface of said tuft carrier such that said tuft carrier can rotate with respect to said mounting surface;
a cam on one of said mounting surface or said lower surface of said tuft carrier;
a cam follower on the other of said mounting surface or said lower surface of said tuft carrier; and
drive means for providing reciprocating motion between said tuft carrier and said mounting surface such that said cam rides up and down on said cam follower.

16. The power toothbrush of claim 15 wherein said reciprocating motion is an arcuate reciprocating motion.

17. The power toothbrush head of claim 16 wherein said drive means includes a drive shaft that is power actuated to rotate about a longitudinal axis, said drive shaft including a tip that engages a slot in said peripheral edge of said tuft carrier.

18. The power toothbrush head of claim 17 wherein said tip includes a finger eccentric with said longitudinal axis, said finger engaging said slot on said tuft carrier as said drive shaft rotates

19. The power toothbrush head of claim 15 including a plurality of said cams circumferentially spaced about one of said boss or said receptacle, and a plurality of said cam followers circumferentially spaced about the other of said boss or said receptacle.
